(19) United States
(12) Patent Application Publication
(10) Pub. No.: US 2015/0036268 A1
(43) Pub. Date: Feb. 5, 2015

(54) ELECTRIC JUNCTION BLOCK

(71) Applicant: E.J. Brooks Company, Farmington Hills, MI (US)

(72) Inventor: Erick William Rudaitis, Sterling Heights, MI (US)

(21) Appl. No.: 13/957,889

(22) Filed: Aug. 2, 2013

(51) Int. Cl. H02B 1/03

(52) U.S. Cl. CPC H02B 1/03
USPC 361/669

(57) ABSTRACT

An electric junction includes an insulated junction block including a passage therein for receiving a conductive insert having a plurality of passages for coupling wires from a utility meter socket with service wires. Several coupling mechanisms for coupling the junction block with the utility meter box provide improved and efficient installation and service of the electric junction. Additionally, a method is disclosed for replacing existing junction blocks with the junction block according to an exemplary embodiment of the present disclosure.

### FIELD

The present disclosure relates to an electric junction block for use in a utility meter box and to apparatuses for coupling a junction block to the utility meter box and related methods.

### BACKGROUND

It is generally known to provide a utility meter for use in measuring the amount of utility service to a location such as a home or business (or generally any facility). It is also generally known to provide a utility meter including a utility meter housing and a utility meter socket. It is also known to include an electric junction in the utility meter for coupling the wires of the utility meter and socket to the wires of the facility receiving service. For example, one generally known prior art example of an electric junction 500 is shown in FIG. 3. The electric junction 500 includes a base 501 that is made of an electrically insulated material and may include a plurality (shown as four (4)) of electric couplings 510. The electric junction 500 is particularly useful in selectively providing electrical connection between the wires 504 of the electric meter socket 2 and the wires 503 of the facility. The base 501 of the electric junction 500 is coupled to a support rail or bracket 14 using a plurality of fasteners 514 such as a threaded bolt and nut. The support rail 14 is coupled to the housing 1 using any known or appropriate coupling mechanism or fastener such as a fastener 5. The base 501 of the electric junction 500 includes a hole or passage 511 including an inwardly extending lip or edge 512. The fastener 514 has a threaded and four being received in a hole (not shown) in the bracket 14. A spacer or washer 513 includes a hole therein for receiving the shank of the fastener 514 and abutting the head of the fastener 514. The spacer 513 has a generally rectangular shape having at least one dimension larger than the opening defined by the edge 512 of the passage 511 for securing the base 501 to the bracket 14. As best shown in FIG. 3, the base 501 may include more than one fastener 514 for securing the base 501 to the support rail 14 within the housing 1.

Referring still to FIG. 3, the base 501 of the electrical junction 500 includes a plurality of electric couplings 510. Each electrical coupling 510 includes a first or bottom plate 515 and a second or top plate 516 for electrically coupling the wires 503 and 504, respectively. Each plate is secured to the base 501 using a fastener of any known or appropriate type. In particular, a threaded shaft secured in the base 501 extends proud of the outer surface of the base 501 and through a hole on the plate 515 and to which a threaded not is fastened. Similarly, for the plate 516, a threaded fastener or bolt are also used to secure the plate 516 to the base 501 as well as the wire 504. The plate 515 includes an extension tab 517 to which the end of wire 503 is fastened using any known or appropriate fastening mechanism such as a box end and bolt. As shown in FIG. 3, the electrical junction 500 of the prior art has many drawbacks since many of the components were made of a metal material which is prone to oxidation and rust. The oxidation shown in FIG. 3 is representative of a long term installation of the electrical junction 500 in a utility box 1. As is well known, the oxidation of the components of the electrical junction 500 leads to degradation in the efficiency of the performance of the unit. Further, as can be seen in FIG. 3, many of the conductive elements of the electrical junction 500 are outwardly facing and openly accessible once the cover is removed from the utility box 1. Since the design of the electrical junction 500 shown in FIG. 3 has been in production and use for many decades, there are a very significant number of utility boxes 1 in the field. Of course, such units have a limited service life. Despite such units being in service for such an extended period of time (well beyond their intended useful life), little has been done to develop an alternative design. Further, despite such units being in service for such extended periods of time and their performance continually degrading, the remains a long felt need for a new design which can replace the electrical junction 500 while addressing the other performance limitations and while making use of the existing infrastructure and components.

### BRIEF DESCRIPTION OF DRAWINGS

FIG. 1 is a plan graphic view of an electric meter housing including an electrical junction block according to an exemplary embodiment of the present disclosure;

FIG. 2 is a partial, perspective view of the electric meter housing including the electric junction block of the exemplary embodiment of FIG. 1;

FIG. 3 is a partial, perspective view of an electric junction for use in a utility meter box according to the prior art;

FIG. 4 is a partial, exploded perspective view of the electric junction block of the exemplary embodiment of FIG. 1;

FIG. 5 is a perspective view of a base member of the junction block of the exemplary embodiment of FIG. 1;

FIG. 6 is a top plan graphic view of the base member of FIG. 5;

FIG. 7 is a partial, end section view taken along the line 7-7 in FIG. 6;

FIG. 8 is a partial, front section view taken along the line 8-8 in FIG. 6;

FIG. 9 is a front view of the base member of FIG. 5;

FIG. 10 is a bottom view of the base member of FIG. 5;

FIG. 11 is a perspective view of a conducting insert of the junction block of the exemplary embodiment of FIG. 1;

FIG. 12 is a side plan view of the conducting insert of FIG. 11;

FIG. 13 is a front plan view of the conducting insert of FIG. 11;

FIG. 14 is an end view of the conducting insert of FIG. 11;

FIG. 15 is a partial, side plan view of the conducting insert and junction block of FIG. 11 with the wires installed;

FIG. 16 is a top plan view of the conducting insert and junction block of FIG. 15;

FIG. 17 is a partial, side plan view of the junction block installed on a support rail of the box according to an exemplary embodiment of the present disclosure;

FIG. 18 is an exploded perspective view of the junction block and support rail of FIG. 17 according to an exemplary embodiment of the present disclosure;

FIG. 19 is an exploded perspective view of the junction block coupler and components of FIG. 17 according to an exemplary embodiment of the present disclosure;

FIG. 20 is a perspective view of the assembled junction block coupler of FIG. 17 according to an exemplary embodiment of the present disclosure;

FIG. 21 is an exploded perspective view of an alternate design junction block coupler and components according to an alternate exemplary embodiment of the present disclosure; and

FIG. 22 is a perspective view of the assembled junction block coupler of FIG. 21 according to the alternate exemplary embodiment of the present disclosure.

### DETAILED DESCRIPTION

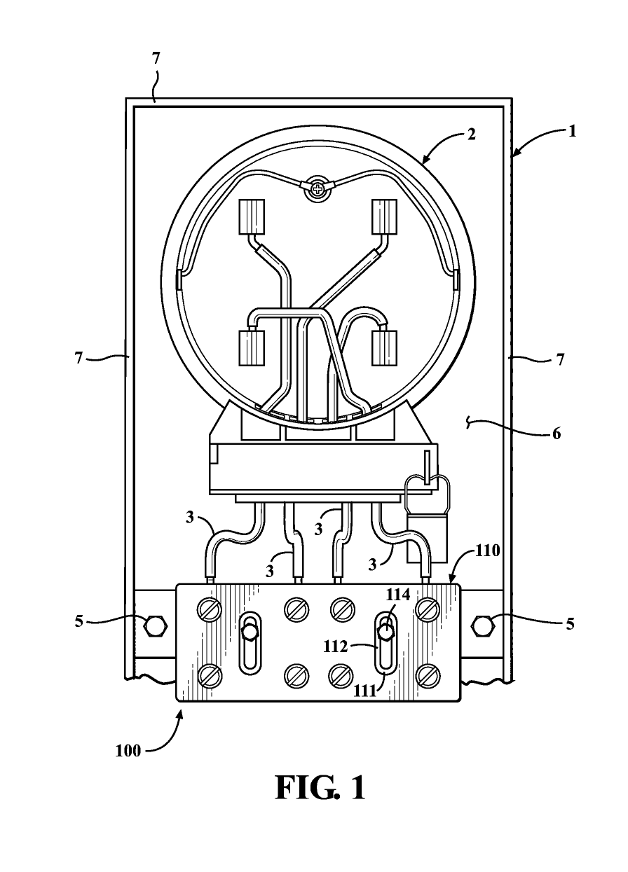

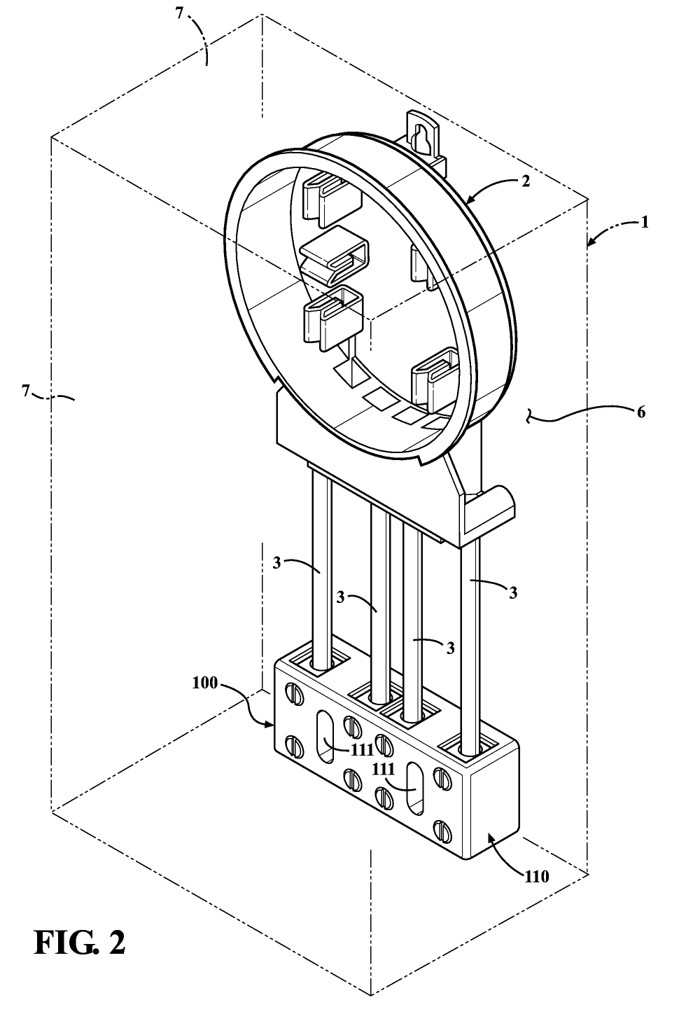

Referring in general to all of the Figures and in particular to FIGS. 1, 2 and 4 through 14, there is disclosed an exemplary embodiment of an electric junction 100 for use in a utility meter box 1, according to the disclosure and teachings of the present application. The electric junction 100 has particular utility and benefits when used with an electric or similar utility meter but may also have significant benefits when used in any known or appropriate apparatus or application.

The electric junction 100 is mounted or coupled in the utility meter box 1. The utility meter box 1 may include a utility meter socket 2 which may be sealed using a securing a glass enclosure (not shown) coupled or secured to the box 1 which is well understood in the art. The utility meter box 1 may include side walls 7 and a back wall 6 as is known in the art. The utility meter box 1 may further include a front wall (not shown) and other components as may be desired or appropriate for a particular application. As best shown in FIG. 1, the utility meter socket 2 is mounted to the back wall 6 of the utility meter box 1. The utility meter socket 2, at its lower end, is coupled to wires 3 for electrically coupling the utility meter socket 2 to the electric junction 100 according to an exemplary embodiment of the present disclosure.

In one particular exemplary embodiment, the electric junction 100 may include a junction body or block 110 made of any known or appropriate electrically insulated material. One particular example of a particularly appropriate and useful material is a glass reinforced polymer material such as moldable plastic or other molding compound having excellent properties of moldability, dimensional stability, electric characteristics, mechanical strength, and heat resistance. In one exemplary embodiment, the injection molded plastic used to produce the block 110 may be a diallyl phthalate, such as that available from Wah Hong Industrial Corp. having product identifier DAP WH-9100. The junction block 110 is preferably formed in an injection molding process but may alternatively be made using any known or appropriate manufacturing process or technique. The junction block 110 is preferably formed having integral passages as explained herein. The junction block 110 is preferably designed to provide a unexpected level of performance compared to the known electric junction 500 and its junction base 501. In particular, the junction base 110 is designed to have no metal components proud of the outer periphery of the junction base 110.

As best shown in FIG. 1, in one exemplary embodiment, the junction base 110 may be coupled to the utility meter box 1 using fasteners 114. The junction base 110 includes a first passage or hole 111 further defined by a inwardly extending lip or edge 112. The passage 111 may have a generally oblong shape or any other known or appropriate shape. The fastener 114 may be a threaded bolt but may be of any known or appropriate type for coupling the block 1102 the utility meter box 1. Similar to the electric junction 500, the utility block 110 of the electric junction 100 may be coupled to a bar, plate or support rail 14 or other intermediate structure which may be coupled or fastened to the utility meter box 1 such as by fasteners 5.

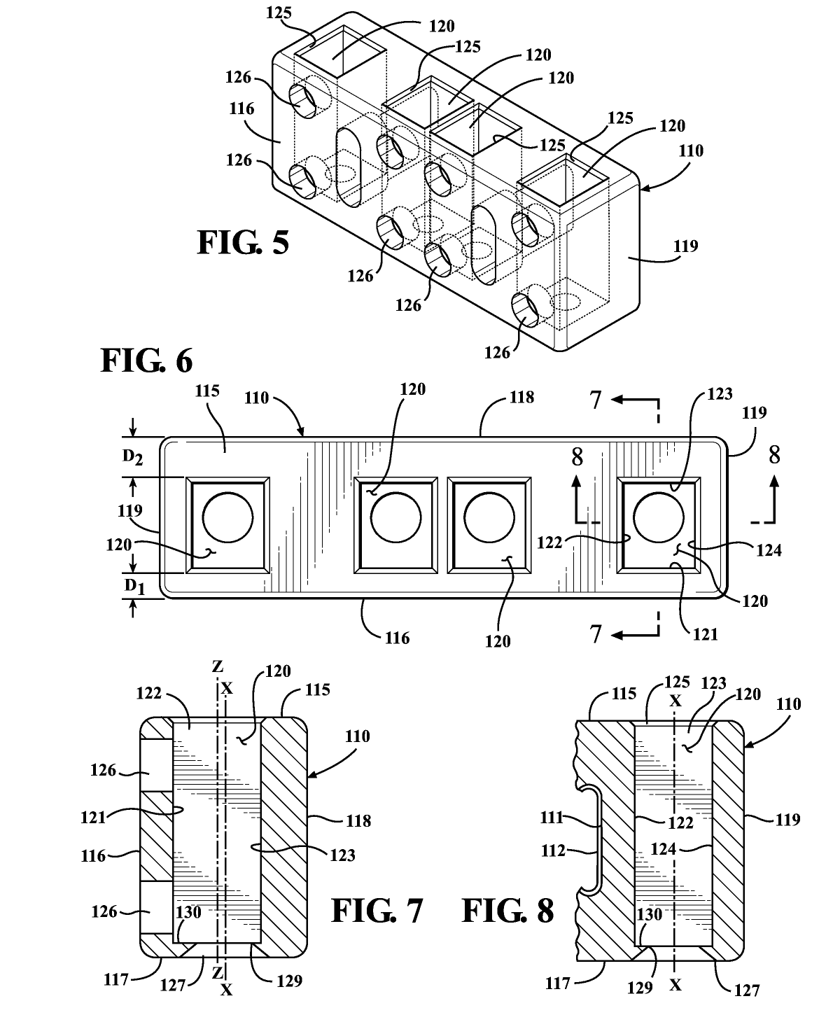

Referring in particular to FIGS. 5 through 10, the junction block 101 has a generally rectangular box shaped. In one exemplary embodiment, the junction block 101 includes a first, top or upper side 115, a front side 116, a bottom side 117, eight backside 118, and first and second ends 119. While the junction block 101 of the present exemplary embodiment as a generally rectangular box shape, it should be appreciated that it is possible that the junction block 101 may have alternative shapes as may be desired or appropriate for a particular application. The junction block 101 includes a plurality of passages 120 for receiving a respective plurality of junction inserts 140. The junction block 110 is shown as including a plurality of passages 120. More particularly, the junction block 110 of the exemplary embodiment includes four passages 120 but may include fewer or greater numbers of passages 120. The four passages 120 are distributed lengthwise along with the junction block body 110. The locations of the passages 120 along the length may be selected for a particular application and/or installation.

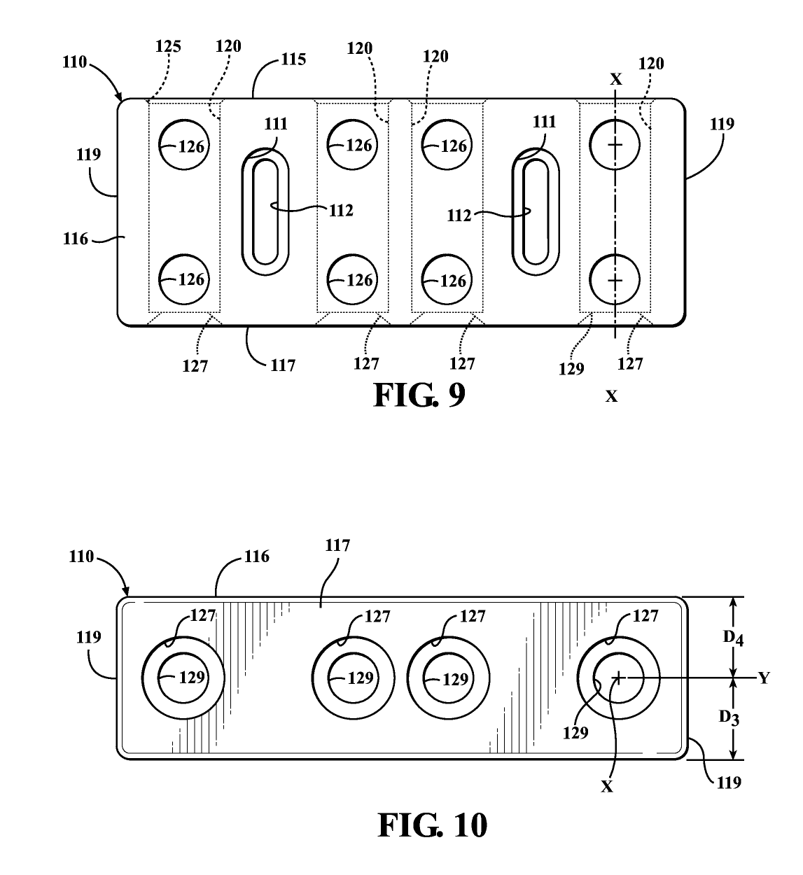

In one exemplary embodiment according to the present disclosure, the locations of the passages 120 along the length of the junction block 110 may be selected to align with the wires 3 extending from the meter socket 2. The junction block 110 is intended to be used to safely and highly effectively house electrical connections between the wires 3 and the wire 504. Each passage 120 is intended to create an isolated electrical connection for its respective pair of wires 3 and 504. Each passage 120 may preferably have a generally rectangular cross section and may extend from an opening 125 in the top side 115 to an opening 127 in the bottom side 117 of the junction block 110. As best shown in FIGS. 7 and 8, openings 125 and 127 may include an angled or chamfered profile which may help with the insertion of the insert 140 into the passage 120 and with the insertion of the ends of the wires into the passage 120 for coupling with the insert 140. The angled chamfer of the opening 125 extends outwardly from the passage 120. The angled chamfer 127 in the bottom 117 of the junction block 110 extends from the bottom 117 of the junction block 110 to an opening 129. It may be appreciated that the angled chamfer opening 125 in the junction block 110 will support the guiding of the wire 104 during installation. Accordingly, the passage 120 further may be further defined by a surface or shelf 130 extending inwardly from the walls 121, 122, 123 and 124 and may further define the opening 129 as best shown in FIGS. 7, 8 and 10. The opening 129 is smaller than the opening 127 and the surface 130 may limit the movement of an object having at least one dimension larger than the diameter of the opening 129 such that the object may be retained within the passage 120 of the junction block 110. Referring in particular to FIG. 9, the furthest right passage 120, it may be seen that the centers of the passages 126 in the front surface 116 of the junction block 110 are aligned with the X axis defined by the center of the opening 129 in the bottom 117 of the junction block 110.

With particular reference now to FIGS. 7, 8 and 10, it may again be noted that each opening 129 of each passage 120 may have a center located along the longitudinal Y-axis of the junction block 110 such that the distances D₃ and D₄ may be substantially equal.

In one particular exemplary embodiment according to the present disclosure, the passage 120 has a rectangular and substantially square cross-section and defines a longitudinally extending Z-axis as best shown in FIG. 7. With particular reference to FIG. 6, it may be noted that each passage 120, while having a generally square cross-section, is located in the junction block 110 such that the first wall 121 of the passage 120 is located closer to the first wall 116 of the junction block 110, as defined by the distance D₁, than is the third wall 123 of the passage 120 located with respect to the back wall 118 of the junction block 110, as defined by the distance D₂. According to an exemplary embodiment of the present disclosure, the distance D₁ may be less than the distance D₂. In the current exemplary embodiment of the present disclosure, the Z-axis may be offset from the X-axis in a direction aligned with the cross-section of the junction block 110 extending from the front side 116 to the backside 118 as best shown in FIG. 7. The offset of the Z-axis from the X-axis improves the efficient installation of the wires 104 with the insert 140 of the junction block 110.

The junction block 110 may further include a plurality of holes or passages 126 according to one exemplary embodiment of the present disclosure. Each passage 126 has an opening on the front side 116 of the junction block 110 and extends there from to a respective passage 120 as best shown in FIGS. 5 and 7. Each passage 126 may preferably be round in cross-section but may alternatively have other shapes. As may be best seen in FIGS. 5, 7 and 9, each passage 120 in the junction block 110 may have first and second passages 126 associated there with. The first and second passages 126 associated with each passage 120 may preferably be aligned and generally located a spaced distance as further described herein.

Each insert 140 may generally be a rectangular, box-shaped object and may be made from a highly electrically conductive metal material such as copper or aluminum. In one particular exemplary embodiment according to the present disclosure, the insert 140 has a generally square cross-section. Preferably, the insert 140 may be made from a metal material which does not corrode or tarnish (or at least corrodes or tarnishes very slowly) with time. In one particular exemplary embodiment according to the present disclosure, the insert 140 may be made from an aluminum-copper clad—tin plated material. Each insert 140 may be made using any known or appropriate method or process of manufacturing. In one particular exemplary embodiment according to the present disclosure, each insert 140 is made using a computer numerical controlled (CNC) machining manufacturing process.

In one particular exemplary embodiment of the present disclosure, the insert 140 includes a first side 141, a second side 142, a third side 143, a fourth side 144, and a top side 145 and a bottom side 147. In general, the sides 141 through 147 each generally have a planar extent and together generally define the rectangular shaped box of the insert 140. The insert 140 may further include a plurality of passages there through providing various functions and features.

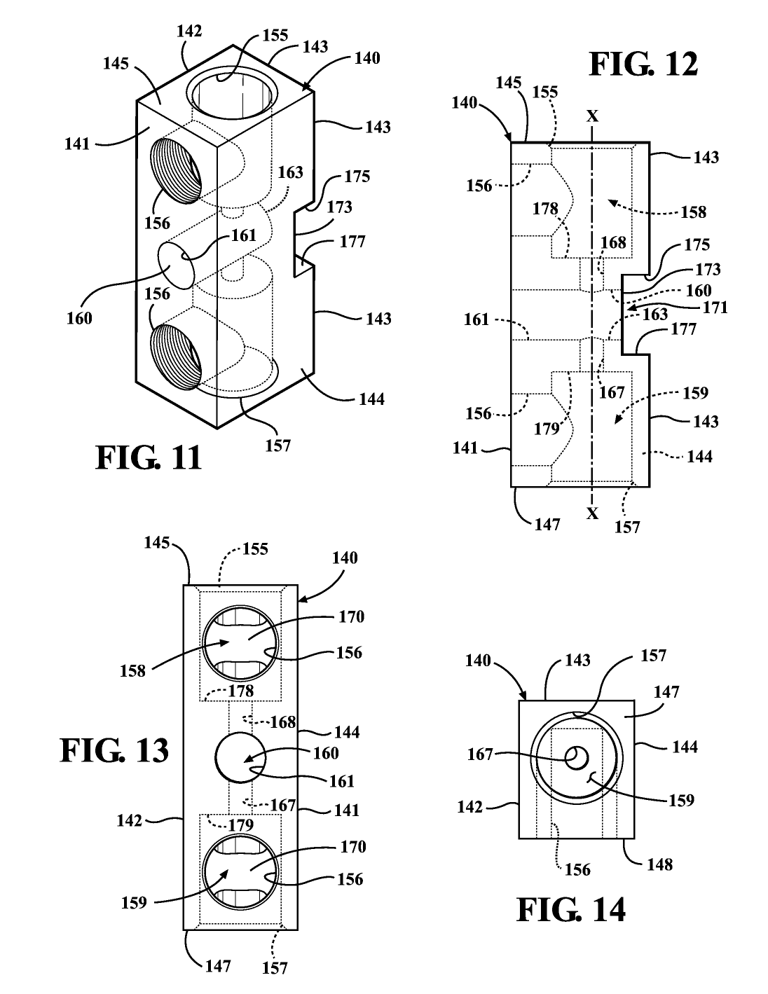

In one exemplary embodiment of the present disclosure, as best shown in FIGS. 11 through 14, the insert 140 may include a passage 158 extending from an opening 155 in the top surface 145 and in a direction toward the bottom surface 147 and to an end surface 178. Similarly, the insert 140 may include a passage 159 extending from an opening 157 in the bottom surface 147 and in a direction toward the top surface 145 and to an end surface 179. The passages 158 and 159 of the insert include a generally longitudinal axis generally defined by the centers of the cross-sections of the passages 158 and 159. The longitudinal axis of the passage 158 and 159 may preferably be coincident with the X-axis of the passage 120 as best shown in FIGS. 8 and 12.

The openings 155 and 157 each may include a chamfer edge. The passage 158 may be in communication with a pilot passage or hole 168 which extends from the end 178 of the passage 158 and in a direction toward the bottom surface 147. Similarly, the passage 159 may be in communication with a pilot passage or hole 167 which extends from the end 179 of the passage 159 and in a direction toward the top surface 145. The insert 140 may further include a centrally aligned and located passage 160 extending from an opening 161 in the first surface 141 and to an opening 163 in the third surface 143. The passage 160 may have a generally round cross-section but may also have cross-section shapes of any known or appropriate type. As may be best observed in FIGS. 12 and 13, the passages 167 and 168 are in communication and intersect the passage 160.

The insert 140 may further include a pair of threaded holes or passages 156 extending from the first side 141 and in a direction toward the third side 143. The first and second threaded holes 156 intersect the passages 158 and 159, respectively. Accordingly, it may be properly observed that all of the passages of the insert 140 are connected and in communication as best shown in FIGS. 11 and 12. Referring still to FIGS. 11 and 12, it is noted that there is a centrally located recessed portion 171 in the third side 143. The recessed portion 171 is defined by a recessed wall 173 which is aligned parallel to the third wall 143 and a top wall 175 and a bottom wall 177. According to the present exemplary embodiment, the passage 160 extends from the first wall 141 to the recessed wall 173. It is contemplated that the insert 140 may or may not include the recessed portion 171 in which instance, the passage 160 would extend to the third wall 143.

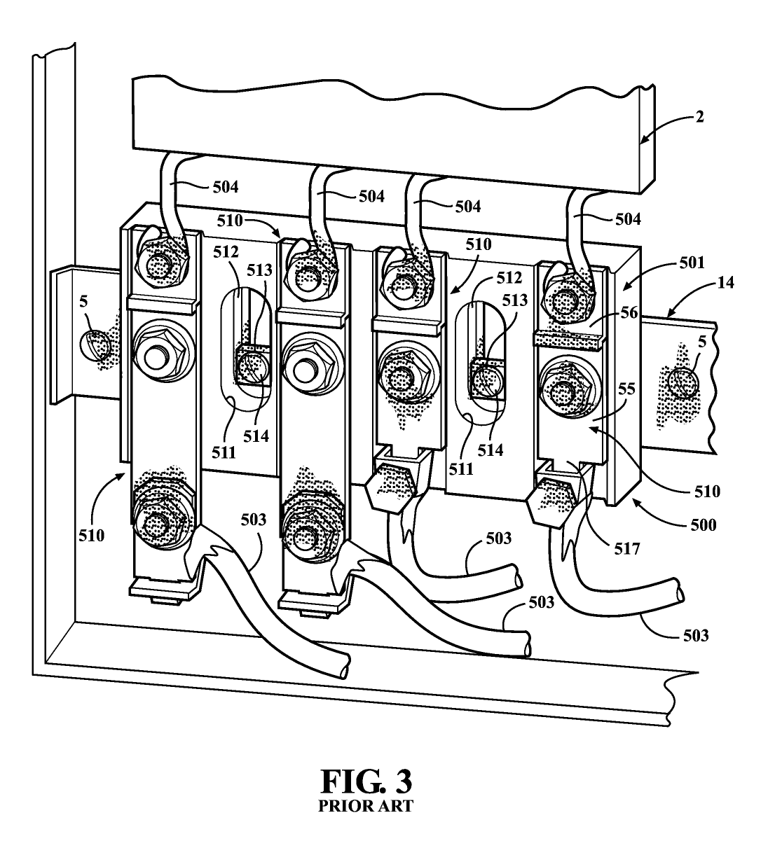

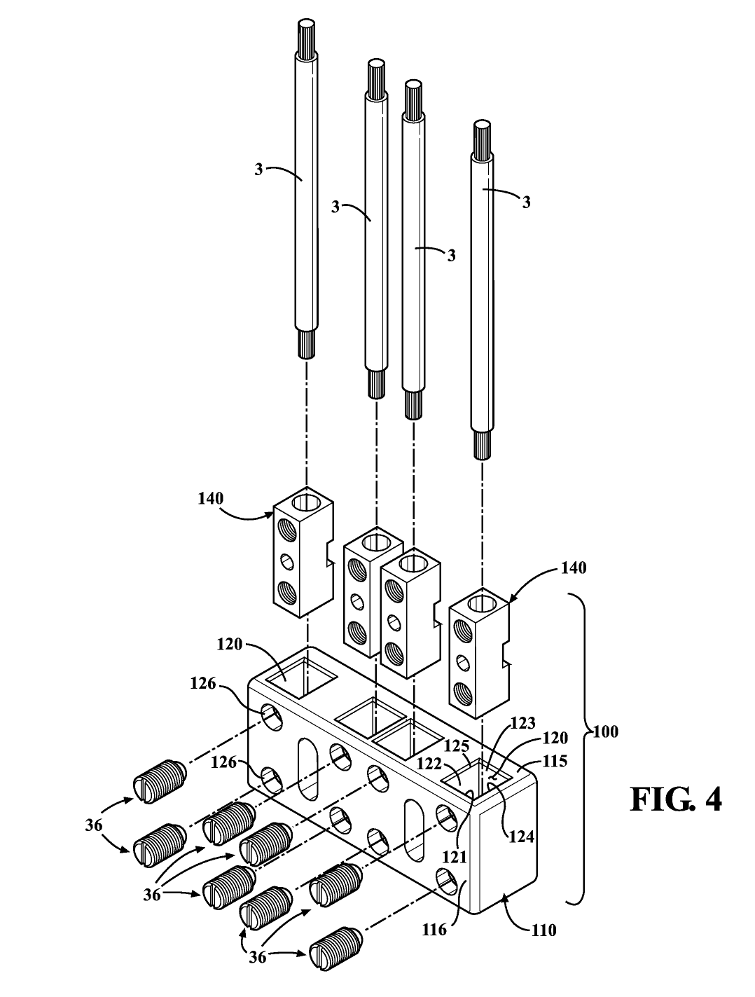

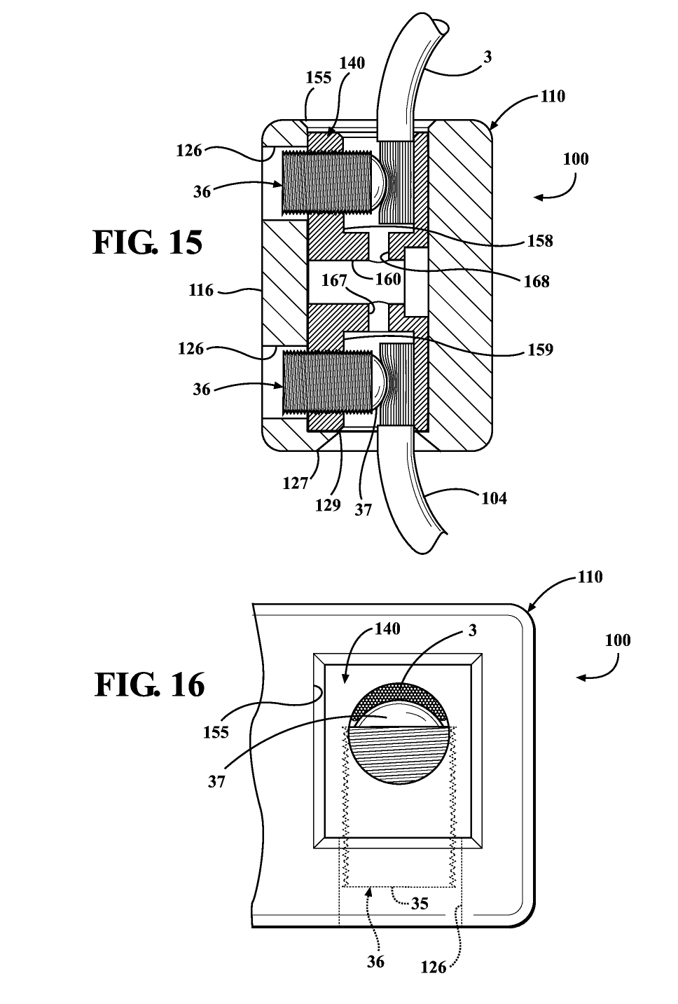

As best shown in FIGS. 4 and 15, the insert 140 may be properly oriented and located in the passage 120 in the junction block 110. Noting the offset of the Z and X axes mentioned above, it may be noted that the offset axes helps to error-proof the installation of the insert 140 in the passage 120. While the insert 140 may still be inserted in the passage 120 in the incorrect orientation, because the axes are offset, the longitudinal axis of the passages 158 and 159 of the insert 140 will be offset from the X-axis of the passage 120. In this incorrect installation position, the passage 159 will be misaligned with the opening 129 in the insert 140 and the wire 104 will be impeded from being inserted into the passage 159. If the insert 140 is not properly oriented when it is installed in the passage 120 of the junction block 110, the user operator will be able to observe the lack of alignment of these physical structures.

Once the insert 140 is properly installed in the passage 120 in the junction block 110, the holes 156 of the insert 140 will be co-aligned with the holes 126 of the junction block 110. Further, the centerline of the opening 157 and the passage 159 of the insert 140 will be co-aligned with the X axis of the openings 129 and 127 of the junction block 110. Once the insert 140 is properly oriented and located in the passage 120 of the junction block 110, the threaded set screws 36 may be aligned with the passage 126 and the threaded hole 156 of the insert 140. According to an exemplary embodiment of the present disclosure, the threads of the threaded set screws 36 are selected to match the threads of the threaded hole 156. The end of the threaded set screws 36 preferably includes a feature or function for engagement by a tool. The set screw 36 is shown as including a slot for a slotted screwdriver but may alternatively use a Philips type slot, a hexagonal shaped slot or any other type of keyed structure for engagement with the driver. As may be best seen in FIGS. 15 and 16, the length of the threaded set screws 36 is preferably selected such that when the threaded set screw 36 is installed and fully engages and holds the conducting elements of a wire, the end 35 of the set screw will be recessed from the surface of the first side 116 of the junction body 110. However, the length of the set screw 36 is also chosen, along with the length D1, such that the end of the set screw 36 will still extend from the insert 140 and be at least partially located in the passage 126 of the junction block 110 such that the set screw 36 will prevent the insert 140 from being removed from the passage 120 as best shown in FIG. 15. The opposite or leading end 37 of the set screw 36 preferably has a rounded or radiused shape for engaging and holding the conductive elements or wires of the electrical wires 3 and 104. In one particular exemplary embodiment of the present disclosure, the end 37 of the screw 36 may have a radiused selected to match a radiused surface 170 of the passages 158 and 159 of the insert 140 as best shown in FIG. 13.

With particular reference to FIGS. 4, 15 and 16, the significant benefit and features of the electric junction 100 may be better understood. Once the junction block 110, the insert 140 and the set screws 36 are manufactured and provided, the insert 140 may properly oriented and then located in the passage 120 of the junction block 110. Next, at least one set screw 36 is threaded at least part way into the threaded hole 156 of the insert 140. The end of the wire 3 is stripped of any protective coating or barrier so that the conductive elements or wires of the electoral wire 3 may be at least partially inserted into the passage 158 of the insert 140 or until the ends of the electrical wire 3 contact the end 178 of the passage 158. Once the electrical wires 3 is located in the passage 158 and held in place, the screw 36 is tightened so that the and 37 engages the electrical elements of the electrical wire 3 and is sufficiently tightened with sufficient force constantly applied to the electrical wire 3 to retain the electric wire 3 in the passage 158. Before or after the above, the same process is followed for coupling the electrical wire 104 in the passage 159 of the insert 140.

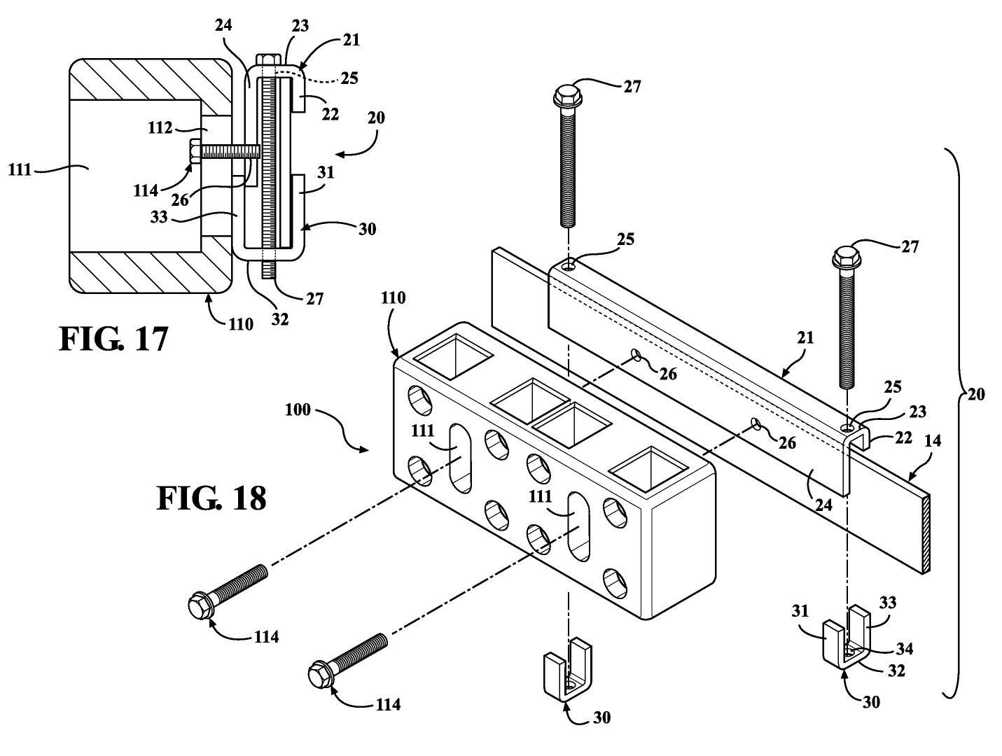

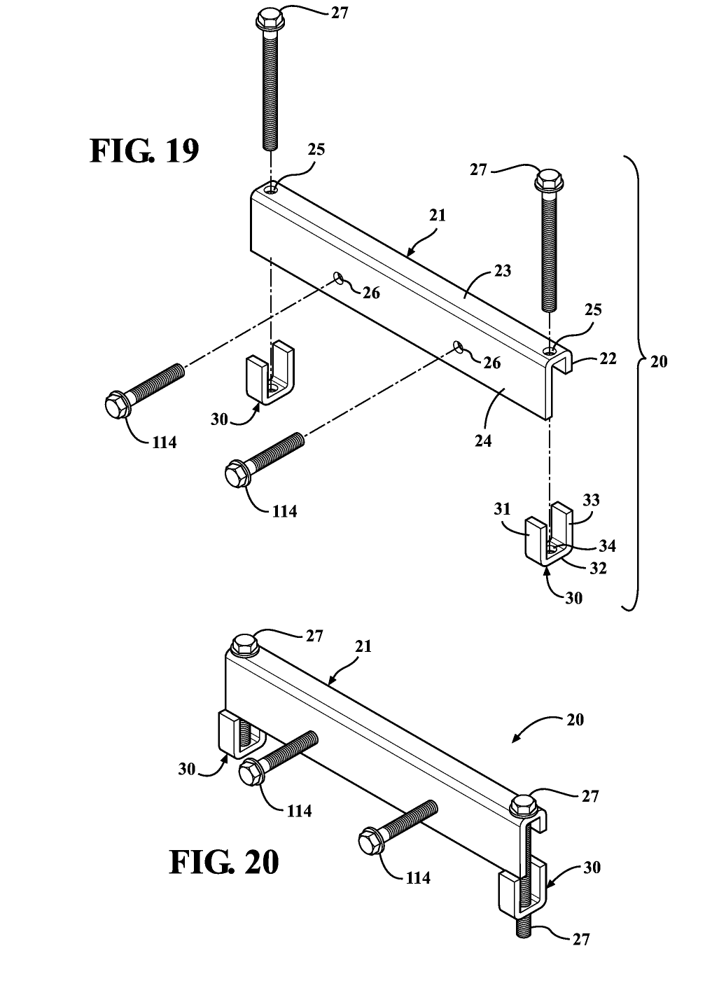

Referring now in particular to FIGS. 17 through 20, there is disclosed a coupling mechanism 20 having particular use in securing the electric junction 100 of the present disclosure to the utility box 1. As previously noted, the junction block 110 includes the passage 111 having the extending edge 112 and the threaded fastener 114 for securing the junction block 110 to the support rail 14. It should be understood that the electric option 100 may include a washer or spacer 513 on the threaded fastener 114 or, alternatively, the threaded fastener 114 may include a shoulder were integral washer for engaging the tags 112 of the passage 111 of the junction block 110. Further, when the junction block 110 was directly secured to the support rail 14 using the threaded fasteners 114 (as is the case with the device disclosed in FIG. 3), service and coupling of the electric wires 3 and 104 may be unnecessarily complicated and/or difficult due to space constraints within the utility box 1. The coupling mechanism 20 of the exemplary embodiment of the present disclosure provides one potential solution to such problems.

In one exemplary embodiment of the present disclosure, the coupling mechanism 120 includes a first rail or hanger member 21 having a generally J-shaped configuration as can be observed best in FIGS. 17 and 18. The hanger member 21 includes a first leg or portion 22, a second, middle or bight portion 23, and a third leg or portion 24 which collectively make up the J-shaped configuration. The second leg or portion 23 may define a distance between the first leg or portion 22 and the second leg or portion 24 so that the hangar member 21 may be coupled or engaged with the support rail 14 of the utility meter box 1. In one exemplary embodiment of the present disclosure, the second leg 23 may define a distance greater than the width of the support rail 14. Referring now in particular to FIG. 17, it may be observed that the second leg 23 Main define a distance between the first leg 22 and the third leg 24 sufficient for the width of the support rail 14 and the width of a fastener 27. The second leg 23 and may include first and second holes 25 for receiving first and second fasteners 27, respectively. According to the an exemplary embodiment of the present disclosure, the first and second holes 25 are not threaded and are sized so that the first and second fasteners 27 may freely passed there through. An alternative embodiment of the present disclosure, the first and second holes 25 may be threaded. The coupling mechanism 120 further includes first and second clips 30 having a generally U-shaped configuration. The first and second clips 30 are coupled to the first and second fasteners 27, respectively, for forming a clamping arrangement around the support rail 14.

The first and second clips 30 each include a first leg 31, a second, middle or bight portion 32 and a third leg or portion 33 and have a generally U-shape configuration. The second leg 32 includes a threaded hole 34 for receiving and end of the threaded fastener 27. Similar to the hangar member 21, the second leg 32 of the clip 31 is sized for receiving the width of the support rail 14 and the width of the threaded fastener 27. Additionally, in one exemplary embodiment of the present disclosure, the second leg 32 of the clip 31 is sized so that the third leg 33 may overlap and extend outwardly of the third leg 24 of the hangar member 21 when the coupling mechanism 20 is installed on the support rail 14 as best shown in FIG. 17. In particular, the third leg 33 of the clip member 30 engages the backside 118 of the junction block 110 at a location below the threaded fastener 114. The threaded fastener 114 passes through the passage 111 and the passage defined by the extension 112 and is received in the threaded hole 26 of the third member 24 of the hangar member 21.

In one exemplary embodiment according to the present disclosure, the junction block 110 may be first fastened loosely to the hangar member 20 using the threaded fasteners 114 received in the threaded holes 26 of the third leg 24. With the threaded fasteners 114 loosely coupled to the hangar member 2, the combination may be coupled to the support rail 14 of the utility meter box 1 by positioning the hangar member 20 on the support rail 14 and the upper edge of the support rail contacting the inner surface of the middle portion 23 of the hangar member 21. Next, the first and second threaded fasteners 27 may be passed through the first and second holes 25, respectively, in the second or middle portion 23 of the hangar member 21. The ends of the first and second threaded fasteners 27 are next coupled to the threaded holes 34 of the first and second U-shaped clip members 30, respectively. In this configuration, the junction block 110 is loosely but securely coupled to the support rail 14 and may be easily removed from the support rail and placed back on the support rail 14 such as may be desirable or necessary during installation and/or repair of the wires. Accordingly, now the installation procedure may be completed.

Continuing the installation procedure, the first and third legs 31 and 33, respectively, of the U-shaped clip 30 are positioned so that the first leg 31 is on the back side of the support rail 14 and the third leg 33 is located on the outside of the third portion 24 of that hangar member 21. The threaded fasteners 27 are substantially tightened so that the hangar member 21 and the U-shaped clips 30 clamp around the support rail 14. The threaded fasteners 114 are then substantially tightened so the junction block 110 is fully secured to the hangar member 21 and therefore the support rail 14 and the electric meter box 1. The above installation process may be substantially reversed to remove the junction block 110 such as may be desirable during maintenance, moving or other activities.

It should be noted that the location of the threaded fasteners 27 and the U-shaped clips 30 are such that they are located distal the ends of the junction block 110. Since the Jay shaped hangar member 21 may be coupled to the junction block 110 prior to installation on the support rail 14, the installation process of the present exemplary embodiment is significantly easier and quicker than trying to align the threaded fastener 114 with the holes in the support rail 14.

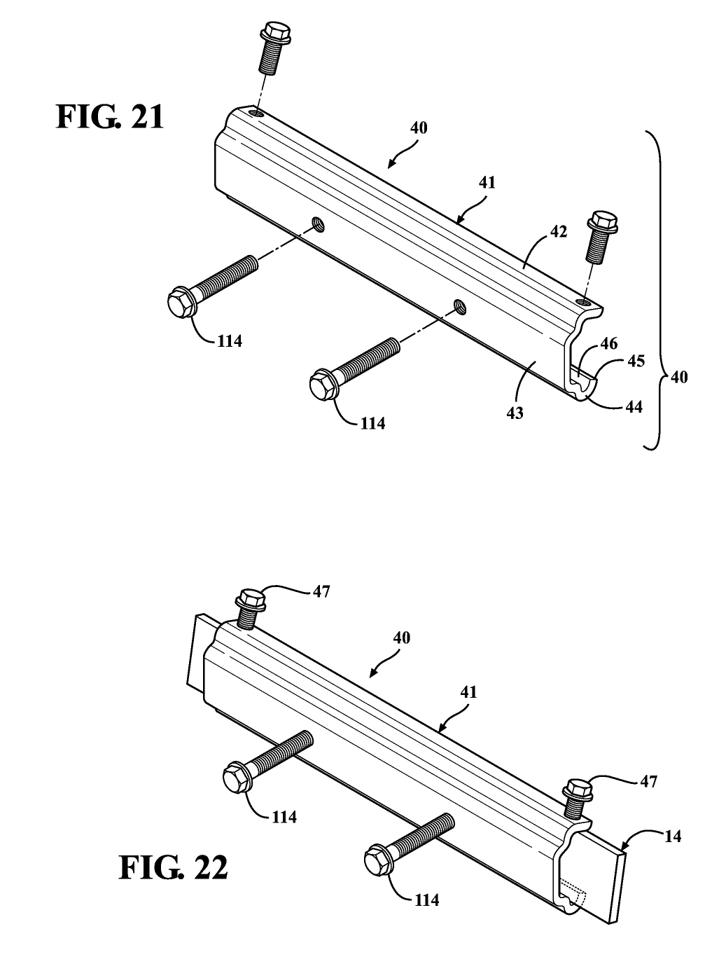

Referring now in particular to FIGS. 21 and 22, there is shown an alternate exemplary embodiment of the present disclosure for a novel and improved coupling member 40 including a hangar member 41. The coupling member 40 functions similarly and has some similar features as the coupling member 20 with a few minor changes and improvements. The hangar member 41 is a generally c-shaped object in cross-section and includes an upper surface or portion 42, a middle side or portion 43, and a lower surface or portion 44 including the end or lip 45. The hangar member 41 includes an inwardly projecting curved surface 46 (i.e., concave inward) located in the lower portion 44. Notably, the end or lip 45 is located closer to the upper surface or portion 42 than the surface 46. The curved surface 46 is preferably substantially designed to match and engage the bottom of the support rail 14 as best shown in FIG. 22. Accordingly, to install the coupling member 40, the junction block 110 is coupled to the hangar member 41 using the fasteners 114.

Although, in the present exemplary embodiment it is not necessary (but optional), it is still possible to first loosely couple the junction block 110 to the hangar member 41. The bottom or lower portion 44 is first located proximal the bottom or lower end of the support rail 14 so that the bottom of the support rail 14 is received in the curved surface 46 of the hangar member 41. The hangar member 41 is then rotated toward the support rail 14 until the support rail 14 is substantially aligned proximal the middle side 43 and the threaded fastener 47 is then rotated so the end of the threaded fastener 47 is located on the backside of the support rail 14 thereby coupling the hangar member 41 to the support rail 14. Currently, the junction block 110 is also now coupled to the support rail 14 and the utility meter box 1. Similar to the coupling mechanism 20, the coupling mechanism 40 is preferably sized and designed such that the threaded fasteners 47 are again located distal the ends 119 of the junction block 110 when it is installed on the hangar member 41 such that the threaded fasteners 47 may be easily accessed by an operator installing or uninstalling the junction block 110. To uninstall the coupling mechanism 40, the above procedure again may be reversed.

The above installation and removal procedures are particularly useful with the very large and substantial installed base of utility meter boxes 1 each including the meter socket 2 and the support rail 14. Since the junction block 500 of the installed base has deteriorated significantly, and with it it's electrical performance, any improvement in the process of replacing the junction block 500 with the junction block 100 of the exemplary embodiments of the present disclosure, even if only to improve the installation process of the junction block 100, can lead to very significant improvements in savings.

Any numerical values recited herein or in the figures are intended to include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.00011, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless expressly stated, all ranges are intended to include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The use of the term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

The disclosure of “a” or “one” to describe an element, ingredient, component or step is not intended to foreclose additional elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps.

It is understood that the present description is intended to be illustrative and not restrictive. Many embodiments as well as many applications besides the examples provided will be apparent to those of skill in the art upon understanding the present disclosure. The scope of the claimed invention should, therefore, not be determined with limiting reference to the description, but should instead be determined with reference to the appended claims, along with the full scope of equivalents to which such claims are entitled. Any disclosure of an article or reference, including patent applications and publications, is incorporated by reference herein for all purposes. Any omission in the following claims of any aspect of subject matter disclosed herein is not a disclaimer of such subject matter.

What is claimed is:

1. An electric junction, comprising:
a junction body formed from an electrically insulated material and having a generally rectangular shape and including a first passage having a plurality of sides and extending from an opening in a first surface of the junction body and toward a second surface of the junction body, the junction body having second and third passages extending from respective openings in the second surface of the junction body, the junction body having a third surface substantially parallel with the first surface of the junction body, the junction body including an opening in the third surface and in communication with the first passage of the junction body, and wherein the second surface is substantially orthogonal with the first surface and wherein the first passage defines an axis; and
an electrically conductive insert located in the first passage of the junction body, the electrically conductive insert including a first passage in a top portion proximal the first surface of the junction body and extending in a direction toward the third surface of the junction body and a second passage in a bottom portion located proximal the opening in the third surface of the junction body and the second passage extending in a direction toward the first passage of the insert and wherein the first and second passages of the insert define an axis that is offset from the axis of the passage.

2. The electric junction of claim 1, further comprising a first set screw located in the second passage of the junction block and having a first end extending into the first passage in the insert for coupling a first wire to the insert.

3. The electric junction of claim 2, further comprising a second set screw located in the third passage of the junction block and having a first end extending into the second passage in the insert for coupling a second wire to the insert.

4. The electric junction of claim 2, wherein the first set screw located in the second passage of the junction block couples the insert to the junction block.

5. The electric junction of claim 1 wherein the first and second chambers of the insert are in communication such that any fluid in the first chamber may travel to the second chamber and out of the insert and out of the junction block due to the force of gravity.

6. The electric junction of claim 1 further comprising:
a fourth passage having a plurality of sides and extending from a second opening in the first surface of the junction body and toward the second surface of the junction body, the junction body having fifth and sixth passages extending from respective openings in the second surface of the junction body and intersecting the fourth passage; and
a second electrically conductive insert having a generally rectangular shape and including a first passage having a plurality of sides and extending from an opening in the first surface of the junction body and toward the second surface of the junction body, the second insert having a second passage extending from an opening in the second surface of the insert and toward the first surface of the insert and wherein the first and second passages of the second insert are in communication.

7. The electric junction of claim 5 further comprising:
a seventh passage having a plurality of sides and extending from a third opening in the first surface of the junction body and toward the second surface of the junction body; and
a third insert having a generally rectangular shape and including a first passage having a plurality of sides and extending from an opening in the first surface of the junction body and toward the second surface of the junction body, the insert having a second passage extending from an opening in the second surface of the insert and toward the first surface of the insert and wherein the first and second passages of the insert are in communication.

8. An electric junction, comprising:
a junction body formed from plastic material and having a generally rectangular shape and including a first passage having a plurality of sides and extending from an opening in a first surface of the junction body and toward a second surface of the junction body, the junction body having second and third passages extending from respective openings in the second surface of the junction body, the junction body having a third surface substantially parallel with the first surface of the junction body, the junction body including an opening in the third surface and in communication with the first passage of the junction body, and wherein the second surface is substantially orthogonal with the first surface and wherein the first passage defines an axis;
an electrically conductive insert located in the first passage of the junction body, the electrically conductive insert including a first passage in a top portion proximal the first surface of the junction body and extending in a direction toward the third surface of the junction body and a second passage in a bottom portion located proximal the opening in the third surface of the junction body and the second passage extending in a direction toward the first passage of the insert and wherein the first and second passages of the insert define an axis that is offset from the axis of the passage; and
a first set screw located in the second passage of the junction block and having a first end extending into the first passage in the insert for coupling a first wire to the insert and for coupling the insert to the junction block.

9. An electric junction, comprising:
a junction body formed from plastic material and having a generally rectangular shape and including a first passage having a plurality of sides and extending from an opening in a first surface of the junction body and toward a second surface of the junction body, the junction body having second and third passages extending from respective openings in the second surface of the junction body, the junction body having a third surface substantially parallel with the first surface of the junction body, the junction body including an opening in the third surface and in communication with the first passage of the junction body, and wherein the second surface is substantially orthogonal with the first surface and wherein the first passage defines an axis;
an electrically conductive insert located in the first passage of the junction body, the electrically conductive insert including a first passage in a top portion proximal the first surface of the junction body and extending in a direction toward the third surface of the junction body and a second passage in a bottom portion located proximal the opening in the third surface of the junction body and the second passage extending in a direction toward the first passage of the insert and wherein the first and second passages of the insert define an axis that is offset from the axis of the passage;
a first set screw located in the second passage of the junction block and having a first end extending into the first passage in the insert for coupling a first wire to the insert and for coupling the insert to the junction block; and
a coupling member for coupling the junction block to a utility meter box, the coupling member including a hangar member, the hangar member having a generally c-shaped cross-section including an upper portion, a middle portion, and a lower portion and wherein the hangar member includes an inwardly projecting curved surface located in the lower portion for engaging a bottom of a support rail of an electric utility box.

10. The electric junction of claim 9 further wherein the hangar member further includes an end located closer to the upper portion than the inwardly projecting curved surface.

11. The electric junction of claim 9, further comprising a second set screw located in the third passage of the junction block and having a first end extending into the second passage in the insert for coupling a second wire to the insert and for coupling the insert to the junction block.

12. The electric junction of claim 9 wherein the first and second chambers of the insert are in communication such that any fluid in the first chamber may travel to the second chamber and out of the insert and out of the junction block due to the force of gravity.

13. The electric junction of claim 9 further comprising:
a fourth passage having a plurality of sides and extending from a second opening in the first surface of the junction body and toward the second surface of the junction body, the junction body having fifth and sixth passages extending from respective openings in the second surface of the junction body and intersecting the fourth passage; and
a second electrically conductive insert having a generally rectangular shape and including a first passage having a plurality of sides and extending from an opening in the first surface of the junction body and toward the second surface of the junction body, the second insert having a second passage extending from an opening in the second surface of the insert and toward the first surface of the insert and wherein the first and second passages of the second insert are in communication.

14. The electric junction of claim 13 further comprising:
a seventh passage having a plurality of sides and extending from a third opening in the first surface of the junction body and toward the second surface of the junction body; and
a third insert having a generally rectangular shape and including a first passage having a plurality of sides and extending from an opening in the first surface of the junction body and toward the second surface of the junction body, the insert having a second passage extending from an opening in the second surface of the insert and toward the first surface of the insert and wherein the first and second passages of the insert are in communication.

15. The electric junction of claim 9 wherein the first passage of the junction body includes a longitudinal axis and the first passage of the insert includes a longitudinal axis aligned coincident with the longitudinal axis of the first passage of the junction body only when the insert is properly installed in the first passage in the junction body.
